(19) United States
(12) Patent Application Publication
(10) Pub. No.: US 2004/0165553 A1
(43) Pub. Date: Aug. 26, 2004

(54) Mobile terminal capable of switching between voice outputs and voice processing method for voice switching-based concurrent service provision

(75) Inventor: Kwang-Hee Park, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/783,834

(22) Filed: Feb. 20, 2004

(30) Foreign Application Priority Data
Feb. 21, 2003 (KR) 10936/2003

(51) Int. Cl. H04Q 7/00; H04Q 7/28

(52) U.S. Cl. 370/329; 370/341

(57) ABSTRACT

A voice processing method in a mobile terminal which provides for a concurrent service that concurrently provides at least two services, each service requiring voice output. Services that can be provided as the concurrent service are first prioritized. The priority levels of a first service and a second service are compared if the second service is to be received during the first service in progress. One of the first and second services that has a higher priority level is selected and voice from the selected service is output.

### PRIORITY

This application claims priority under 35 U.S.C. § 119 to an application entitled “Mobile Terminal Capable of Switching between Voice Outputs and Voice Processing Method for Voice Switching-Based Concurrent Service Provision” filed in the Korean Industrial Property Office on Feb. 21, 2003 and assigned Serial No. 2003-10936, the contents of which are incorporated herein by reference.

### BACKGROUND OF THE INVENTION

1. Field of the Invention

The present invention relates generally to a mobile communication service, and in particular, to the provision of a concurrent service in a mobile communication system.

2. Description of the Related Art

As known, a mobile terminal receives only a single service at one time over 2^{nd} generation mobile communication networks, e.g. DCN and PCS. In other words, it cannot receive various services, such as a voice service and a packet data service, concurrently. Hence, a call process model is also configured to process a single service. To receive a different service during an ongoing service, the service connection is switched over to the new service by service negotiations via radio interfaces, interrupting the ongoing service.

However, a concurrent service is a requisite function of a 3^{rd} generation mobile communication network in a multimedia environment. The concurrent service refers to concurrent provision of different services (e.g., voice and packet data services) without interrupting an ongoing service. This is impossible with conventional call process models and procedures in the 2^{nd} generation mobile communication networks.

Studies have been actively conducted on the concurrent service over the 3^{rd} generation mobile communication network in a multimedia environment, as disclosed in Korean Patent Laid-Open Publication No. 2001-0090441 entitled “Method of Providing Concurrent Service in a Mobile Communication System” (assigned to Samsung Electronics on Oct. 18, 2001) and Korean Patent Laid-Open Publication No. 2002-0034390 entitled “Concurrent Service Method in a Mobile Communication System” (assigned to LG Electronics on Jun. 26, 2002)

From a mobile terminal's point of view, the concurrent service means simultaneous reception of various services, for example, video-on-demand (VOD) and voice call, video call and VOD, or voice call and web surfing.

A technique of controlling between different voice service devices including a mobile terminal is disclosed in EPO Laid-Open Publication No. EPO923843 (WO9810612) (assigned to Ericsson Inc. On Mar. 12, 1998), entitled “Interface System for Providing Hands-Free Operation of a Radiotelephone and Communication to Accessories in a Mobile Office Environment.” Since this Laid-Open application only deals with interfaces between different voice service devices, it does not disclose how various services can be received concurrently in a mobile terminal.

Therefore, when a mobile terminal receives a voice service during a moving picture service, how voice is processed in the mobile terminal having a single connection to a speaker and an earphone emerges as a challenging issue. Processing voice outputs from different services in the mobile terminal has not been addressed yet. Thus, it is necessary to explore a method of processing voice outputs for providing a concurrent service to a mobile terminal.

### SUMMARY OF THE INVENTION

It is, therefore, an object of the present invention to provide a voice processing method in which two or more voice/sound outputs from a concurrent service are prioritized to prevent overlap of the sounds in a speaker and to allow a user to enjoy his desired sound.

It is another object of the present invention to provide a computer-readable recording medium having a program for implementing the voice processing method recorded thereon.

It is yet another object of the present invention to provide a voice processing method for allowing a user to hear his desired voice/sound at a desired time by use of a voice switch for switching between voice outputs from a concurrent service in a mobile terminal.

It is a further object of the present invention to provide a voice switching apparatus for assigning one voice output to an earphone and another voice output to a speaker for a concurrent service in a mobile terminal.

It is still another object of the present invention to provide a voice switching apparatus for switching different voice outputs to different service paths for a concurrent service, to thereby increase the utilization of each service in a mobile terminal.

The above objects are achieved by a voice processing method in a mobile terminal, which provides for a concurrent service that concurrently provides at least two services, each service requiring voice output according to one aspect of the present invention. Services that can be provided as the concurrent service are first prioritized. The priority levels of a first service and a second service are compared if the second service is to be received during the first service in progress. Here, the first service is one of the at least two services and the second service is the other service. One of the first and second services that has a higher priority level is selected and voice from the selected service is output.

According to another aspect of the present invention, a program for performing a plurality of functions, preferably first, second and third functions, is recorded on a computer-readable recording medium in a mobile terminal having a processor. In the first function, at least two services that can be provided as a concurrent service are prioritized. Here, each service requires voice output. In the second function, the priority levels of a first service and a second service are prioritized if the second service is to be received during the first service in progress, the first service being one of the at least two services and the second service being the other service. In the third function, one of the first and second services that has a higher priority level is selected and voice from the selected service is output.

According to a further aspect of the present invention, in a mobile terminal capable of switching between voice outputs, a controller controls functions including mobile communication and wireless Internet connection, a storage stores programs required for the operation of the controller and data, an RF module communicates RF signals with a base station over a mobile communication network through an antenna, a keypad has keys for data input, a voice coder/decoder (CODEC) connected to the controller receives a voice signal from the controller and decodes the voice signal, and a voice switch switches the decoded voice signal received from the voice CODEC to a selected output device under the control of the controller, so that different voice outputs are connected to different output devices.

According to still another aspect of the present invention, in a voice processing method which provides for a concurrent service that concurrently provides at least two services, each service requiring voice output, in a mobile terminal capable of switching different voice outputs to different output devices, services that can be provided as the concurrent service are prioritized. It is then determined whether a first service and a second service are to be provided concurrently if the second service is received during the first service in progress, the first service being one of the at least two services and the second service being the other service. If the first and second services are provided concurrently, voices from the first and second services are output via different output paths. If the first and second services are not provided concurrently, it is determined whether the first and second services are provided as the concurrent service. If the first and second services are not provided as the concurrent service, one of the first and second services is selected and voice from the selected service is output. If the first and second services are provided as the concurrent service, one of the first and second services that has a higher priority level is selected and voice from the higher-priority service is output.

According to yet another aspect of the present invention, a program for performing a plurality of functions, preferably first to fifth functions, is recorded on a computer-readable recording medium in a mobile terminal having a processor and capable of switching different voice outputs to different output devices. In the first function, services that can be provided as a concurrent service are prioritized. In the second function, it is determined whether a first service and a second service are to be provided concurrently if the second service is received during the first service in progress, the first service being one of the at least two services and the second service being the other service. In the third function, if the first and second services are provided concurrently, voices from the first and second services are output via different output paths. In the fourth function, if the first and second services are not provided concurrently, it is determined whether the first and second services are provided as the concurrent service, and if the first and second services are not provided as the concurrent service, one of the first and second services is selected and voice from the selected service is output. In the fifth function, if the first and second services are provided as the concurrent service, one of the first and second services that has a higher priority level is selected and voice from the higher-priority service is output.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates the configuration of a mobile communication system to which the present invention is applied;

FIG. 2 is a block diagram of a typical mobile terminal to which the present invention is applied;

FIG. 3 is a flowchart illustrating an embodiment of voice processing for a concurrent service in the typical mobile terminal according to the present invention;

FIG. 4 illustrates an example of a service priority window displayed for voice processing involved with the concurrent service in the typical mobile terminal according to the present invention;

FIG. 5 is a block diagram of a voice processor in a mobile terminal capable of switching between voice outputs according to an embodiment of the present invention;

FIGS. 6A to 6D illustrate embodiments of switching in a voice switch illustrated in FIG. 5 in the mobile terminal capable of switching between voice outputs according to the present invention;

FIGS. 7A and 7B illustrate a voice output selection window in the mobile terminal capable of switching between voice outputs according to the embodiment of the present invention; and

FIG. 8 is a flowchart illustrating voice processing for a concurrent service in the mobile terminal capable of switching between voice outputs according to the embodiment of the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

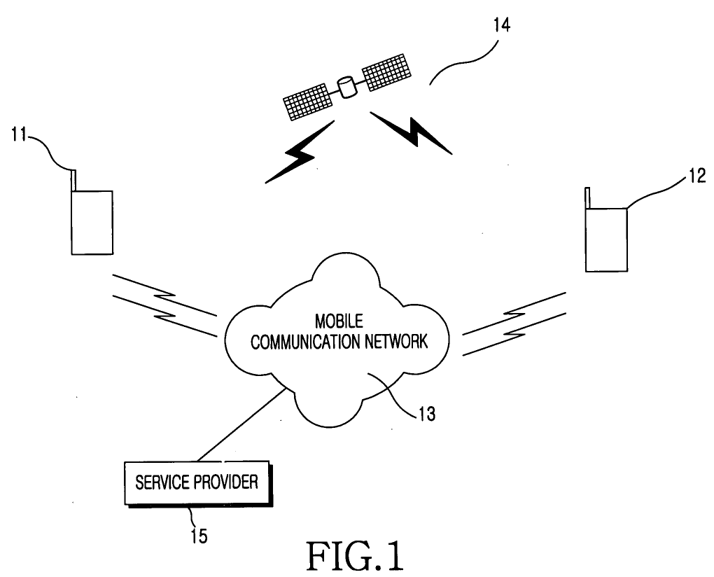

FIG. 1 illustrates the configuration of a mobile communication system to which the present invention is applied. It is assumed herein that the mobile communication system is a 3^{rd} generation system. The service configuration of the mobile communication system will be described below with respect to a first mobile terminal 11.

Referring to FIG. 1, during a voice call with a second mobile terminal 12 over a mobile communication network 13, the first mobile terminal 11 can receive multimedia information from a service provider 15, or broadcasting such as digital audio broadcasting (DAB) from a satellite 14.

For details of a concurrent service that concurrently provides two types of information for a voice call service, a multimedia service, and a broadcasting service, reference is made to the aforementioned Laid-Open applications, Korean Patent Laid-Open Publication No. 2001-0090441 and Korean Patent Laid-Open Publication No. 2002-0034390.

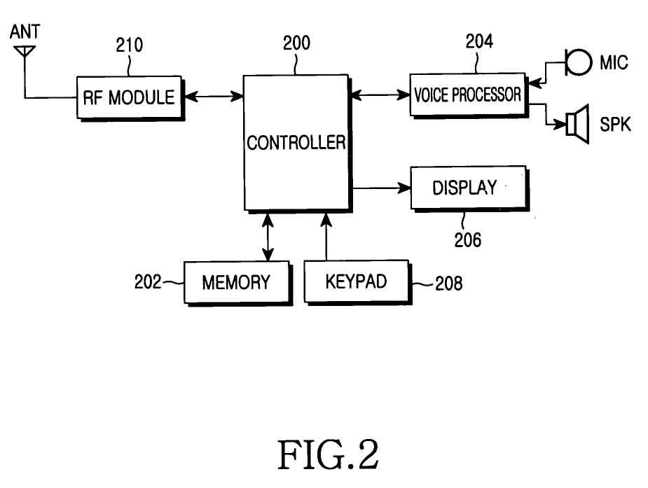

FIG. 2 is a block diagram of a typical mobile terminal. Referring to FIG. 2, a controller 200 takes charge of signal processing and control for functions including voice call, wireless Internet connection, and voice processing for a concurrent service according to the present invention. A memory 202 is comprised of a read only memory (ROM) for storing the microcodes of operation and control programs and look-up data for the operation of the controller 200, a random access memory (RAM) as a working memory for the controller 200, and a flash RAM for providing an area to store updatable data including multimedia data. In accordance with the present invention, the flash RAM also stores information about the priority levels of services that are provided as a concurrent service. A voice processor 204, connected to the controller 200, processes a voice call, records voice, and alerts a user about incoming calls through a microphone (MIC) and a speaker (SPK). A display 206 displays data visually. A keypad 208 has numerical keys ranging from 1 to 0 and function keys such as Menu, Send, Clear, End, *, #, and Volume, and provides key input data corresponding to a pressed key to the controller 200. A radio frequency (RF) module 210 transmits and receives an RF signal to and from a base station (BS) through an antenna (ANT) over a mobile communication system.

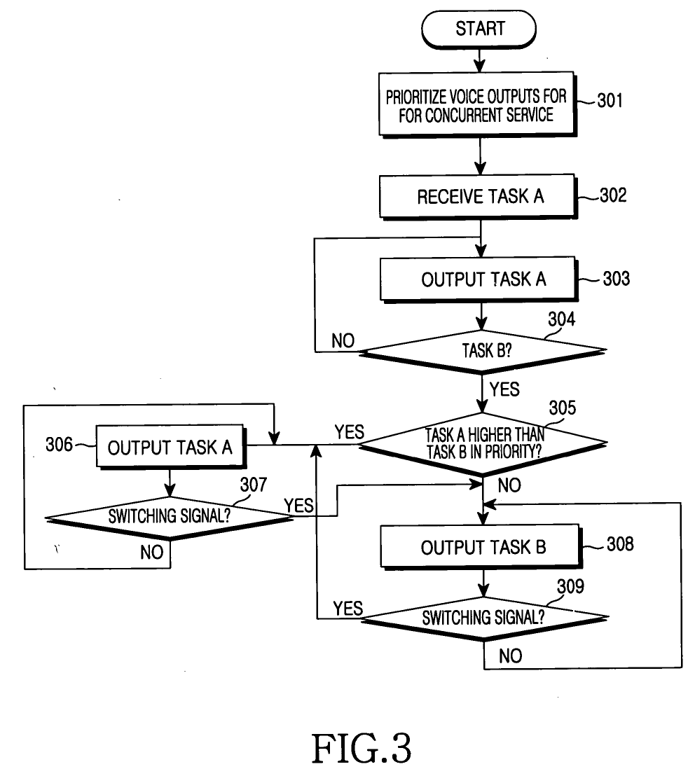

FIG. 3 is a flowchart illustrating voice processing for a concurrent service in the typical mobile terminal according to the present invention. Referring to FIG. 3, the controller 200 prioritizes incoming or received data to be output as voice outputs from services being provided as a concurrent service according to default values preset during manufacture of the mobile terminal, or by user setting in step 301. In other words, the default values are basically adopted, allowing a user to change the default values through the keypad 208.

Upon receipt of task A from a service involving voice output in step 302, the controller 200 provides task A to the voice processor 204 in step 303. If only task A is present, there is no need for voice processing according to the present invention.

In step 304, the controller 200 determines whether task B requiring voice output has been received. In the absence of task B, task A is simply output to the voice processor 204 without any processing in step 303. In the presence of task B, the priority levels of task A and task B set in step 301 are compared in step 305.

If task B has a higher priority, voice from task B is output in step 308. On the other hand, if task A is higher in priority than task B, voice from task A is output to the voice processor 204 in step 306.

In steps 307 and 309, a switching key is pressed to output voice from the remaining task. That is, if a switching signal is generated during the voice output from task B in step 309, voice from task A is output in step 306. In the same manner, if the switching signal is generated during the voice output from task A in step 307, voice from task B is output in step 308. The switching signal can be generated using an unused ASCII code, or a particular key can be designated as a dedicated switching key.

For example, when the mobile terminal user receives a voice call during viewing moving pictures, he hears voice from the other party at the moment he answers the phone if the voice call is of higher priority. To change to the sound of the moving pictures, he presses the switching key during the call. Then sound involved in the moving pictures is output through the speaker. Upon input of the switching key again, the voice of the calling party is output.

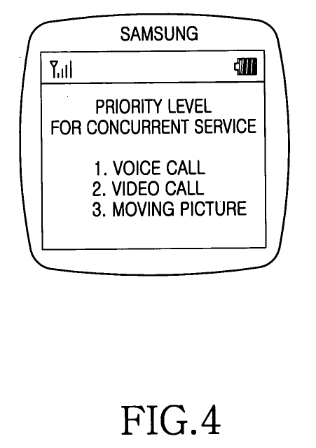

FIG. 4 illustrates an example of a service priority window displayed for voice processing involved with a concurrent service in the typical mobile terminal according to the present invention. Referring to FIG. 4, priority is high in the order of “1. voice call, 2. video call, 3. moving picture” as a concurrent service.

While the services are prioritized, programs for providing the services can be prioritized instead.

A multi-function mobile terminal such as a smart phone is equipped with a plurality of functions for providing moving pictures and there is little distinction between voice call and video call. Thus, programs for services involving voice signals are prioritized, for example, “multimedia player” for offering moving pictures, “telephone program” for enabling voice calls, “video call program” for providing video calls, and “broadcasting program” for receiving broadcast programs. If the programs are not prioritized by a user, they are prioritized according to default values preset in manufacture of the mobile terminal. A program installed by the user, if it remains non-prioritized, is given a priority level following the current last priority level.

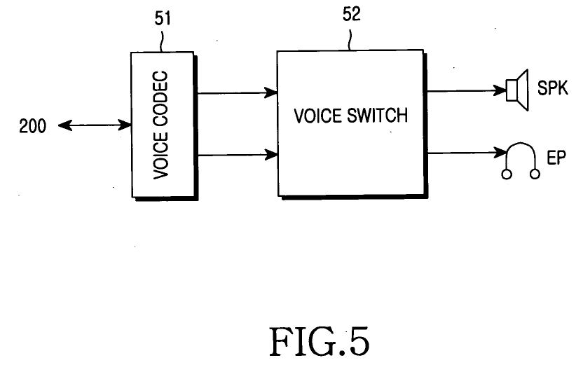

FIG. 5 is a block diagram of a voice processor in a mobile terminal capable of switching between voice outputs according to an embodiment of the present invention. Referring to FIG. 5, the voice processor 204 for processing a voice signal received from the controller 200 is comprised of a voice coder/decoder (CODEC) 51 and a voice switch 52. According to the present invention, the voice processor 204 connects one voice output to the speaker and another voice output to the earphone, or the voice output paths can be exchanged by use of the voice switch 52. The voice CODEC 51 of a typical mobile communication system, especially for IS-95 systems, adopts Qualcomm code excited linear prediction (Q-CELP) or an advanced scheme, enhanced variable rate codec (EVRC). Both schemes enable voice coding at high compression rates, relying on the voice generation principle. A decoded signal is connected to the speaker or earphone through the voice switch 52 in the present invention, which will be described below in more detail.

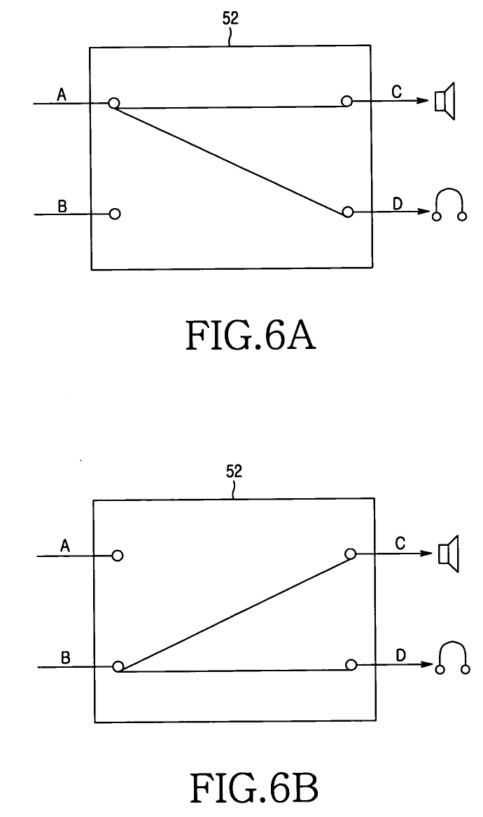

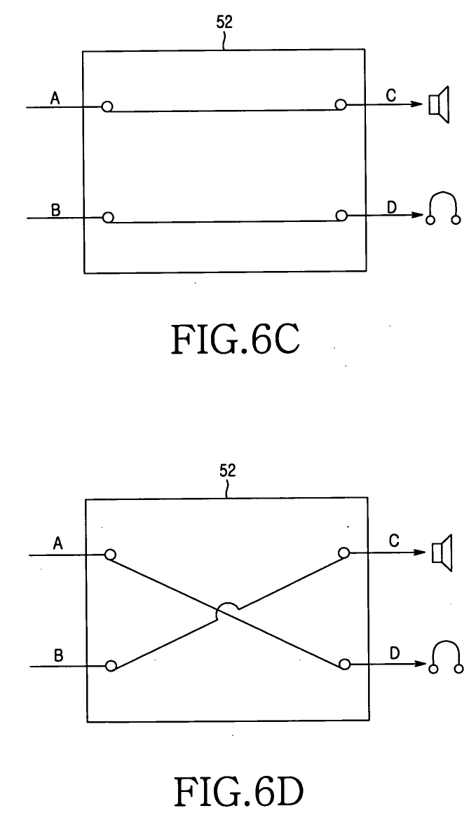

FIGS. 6A to 6D illustrate embodiments of switching in the voice switch 52 in the mobile terminal capable of switching between voice outputs according to the present invention. Referring to FIGS. 6A to 6D, two voice signals A and B are applied to the input of the voice CODEC 51 and two output devices, the speaker C and the earphone D are used. The voice switch 52 connects one voice signal to the two output devices or to one of them in the present invention.

In FIG. 6A, the voice signal A is connected to both output devices C and D. In FIG. 6B, the voice signal B is connected to both output devices C and D. In FIG. 6C, the voice signals A and B are connected to the output devices C and D, respectively. In FIG. 6D, the output paths illustrated in FIG. 6C are exchanged for the voice signals A and B.

The voice output paths are preset by the user. Information about the voice output paths is stored in the memory 202 so that the voice switch 52 establishes the voice output paths using the information. Therefore, the mobile terminal can provide the concurrent service requiring at least two voice outputs by assigning each service to one output device.

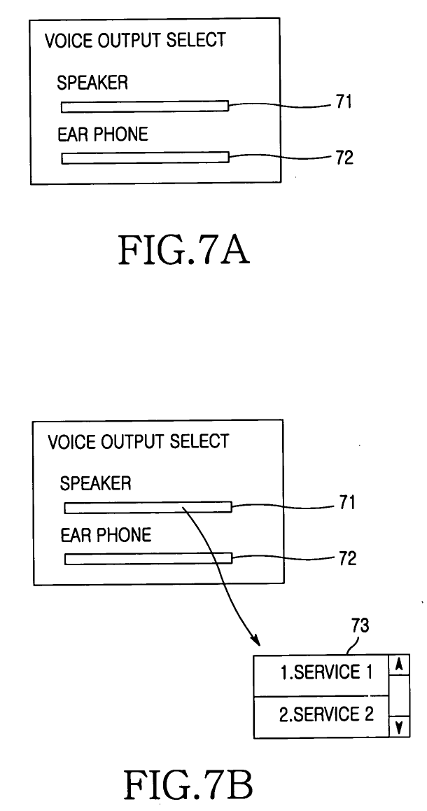

FIGS. 7A and 7B illustrates a voice output selection window in the mobile terminal capable of switching between voice outputs according to the embodiment of the present invention. Referring to FIG. 7B, the voice output selection window prompts the user to select a service for a corresponding output device as indicated by reference numerals 71 and 72. Each window 73 for a corresponding output device displays, for example, “1. service 1, 2. service 2”. Service 1 and service 2 denote the first and second input signals A and B, respectively, from the voice CODEC 51. If the user selects “service 1” for the speaker and “service 2” for the earphone, the first service (e.g. voice call) is received through the speaker and the second service (e.g. MP3) through the earphone.

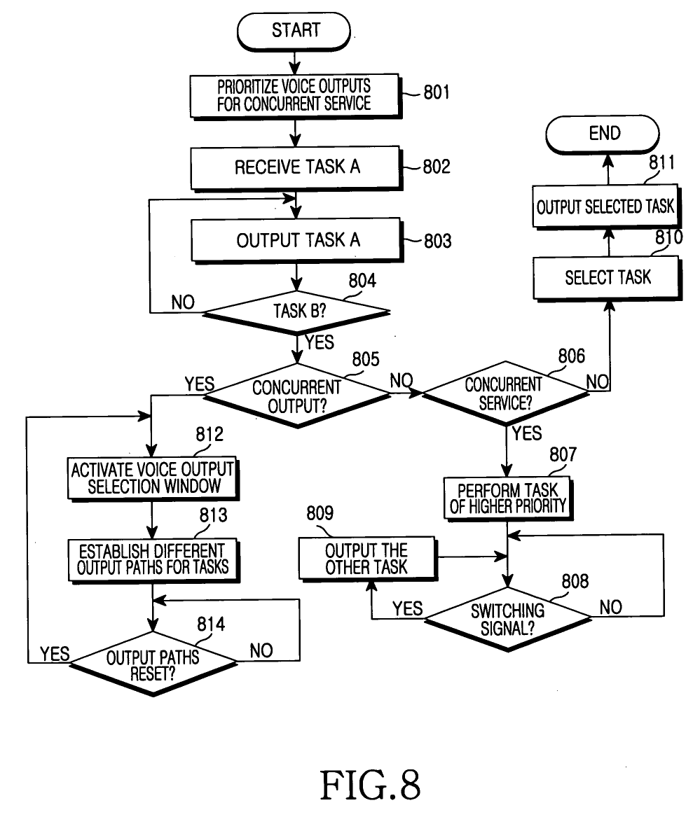

FIG. 8 is a flowchart illustrating voice processing for a concurrent service in the mobile terminal capable of switching between voice outputs according to the embodiment of the present invention.

Referring to FIG. 8, voices from services provided as a concurrent service are prioritized according to default values preset in manufacture of the mobile terminal, or by user selection in step 801. As stated above, the default values are basically adopted, allowing the user to change the default values through the keypad 208.

The controller 200 receives task A from a service involving voice output in step 802 and outputs it to the voice processor 204 in step 803. If only task A is processed, there is no need for voice switching according to the present invention. In step 804, the controller 200 determines whether task B requiring new voice output has been received. In the absence of task B, task A is simply output to the voice processor 204 in step 803. On the contrary, in the presence of task B, the controller 200 determines whether tasks A and B are output simultaneously in step 805. The decision can be made by checking whether services set for the output devices in the voice output selection window are identical, or by prompting the user to select services for the output devices in the window.

If they are not output simultaneously, the controller 200 determines whether they are from the concurrent service in step 806. In the case of the concurrent service, the controller 200 selects a task having a higher priority level and performs the selected task in step 807.

If task B(A) is higher than task A(B) in priority, the controller 200 outputs voice from task B(A) in step 807. The controller then checks for receipt of a switching signal during the voice output from task B(A) in step 808, and if switching signal is received, the controller. 200 outputs task A(B) in step 809. The switching signal can be generated using an unused ASCII code. In addition, a dedicated switching key can be designated.

To describe the above operation more specifically, when the user is wanted for a call during viewing moving pictures, sound from the moving pictures is first output through the speaker and then voice from a caller is output through the speaker the moment the user answers the phone, if the voice call is of higher priority. If the user presses the switching key during the call, sound from the moving pictures is output again through the speaker. Upon input of the switching signal again, the voice call is resumed.

If tasks A and B are not provided simultaneously in step 805, the controller 200 determines whether they are provided as a concurrent service in step 806. If they are not provided as the concurrent service, the controller 200 selects one of the tasks in step 810 and outputs voice from the selected task to the two output devices (i.e., the speaker and earphone) in step 811.

If the tasks are provided simultaneously, the voice output selection window is activated in step 812 and an output path is established for each task in step 813. Upon receipt of a path reset signal in step 814, the procedure returns to step 812. The path reset signal can be generated using an unused ASCII code, or a particular key can be designated as a dedicated path reset key. Path setting in steps 812 and 813 can be performed beforehand. That is, if the tasks are output simultaneously in step 805, voices from the tasks are output in the preset paths.

In accordance with the present invention as described above, (1) voice signals are selectively output according to their priority levels without overlap during a concurrent service as a multimedia function essential to 3rd generation mobile communication, thereby avoiding collision between the voice signals; (2) switching between voice outputs allow a user to hear his intended sound; (3) since output devices are assigned to different services for the provision of services involving different voice outputs as well as the concurrent service, the service can be provided simultaneously; and (4) the voice processing according to the present invention can be implemented in a program recorded on a computer-readable recording medium (e.g., CD ROM, RAM, floppy disk, hard disk, optomagnetic disk, etc.).

While the invention has been shown and described with reference to certain preferred embodiments thereof, they are merely exemplary applications. For example, while two services are provided as a concurrent service, they can be extended to three or four services as long as different voice signals can be assigned to different output devices in a mobile terminal capable of switching between voice outputs. This is facilitated by increasing the number of available services in the voice output selection window illustrated in FIG. 7. Thus, it will be understood by those skilled in the art that various changes in form and details may be made therein without departing from the spirit and scope of the invention as defined by the appended claims.

What is claimed is:

1. A voice processing method in a mobile terminal which provides for a concurrent service that concurrently provides at least two services, each service requiring voice output, comprising the steps of:
prioritizing services that can be provided as the concurrent service;
comparing the priority levels of a first service and a second service if the second service is to be received during the first service in progress,
selecting one of the first and second services that has a higher priority level and outputting voice from the selected service.

2. The voice processing method of claim 1, further comprising the step of, upon input of a voice switching signal during the voice output from the selected service, switching to voice output from the other service.

3. The voice processing method of claim 1, wherein the services are prioritized by user selection.

4. The voice processing method of claim 2, wherein the services are prioritized by user selection.

5. The voice processing method of claim 1, wherein the services are prioritized by prioritizing programs for performing the services.

6. The voice processing method of claim 2, wherein the services are prioritized by prioritizing programs for performing the services.

7. The voice processing method of claim 2, wherein the voice switching signal is generated using a predetermined unused ASCII code.

8. A computer-readable recording medium in a mobile terminal having a processor, comprising a program,
wherein the program performs a first function for prioritizing at least two services that can be provided as a concurrent service, each service requiring voice output, a second function for comparing the priority levels of a first service and a second service if the second service is to be received during the first service in progress, and a third function for selecting one of the first and second services that has a higher priority level and outputting voice from the selected service.

9. A mobile terminal capable of switching between voice outputs, comprising:
a controller for controlling functions including mobile communication and wireless Internet connection;
a storage for storing programs required for the operation of the controller and data;
a radio frequency (RF) module for communicating RF signals with a base station over a mobile communication network through an antenna;
a keypad having keys for data input;
a voice coder/decoder (CODEC) connected to the controller, for receiving a voice signal from the controller and decoding the voice signal; and
a voice switch for switching the decoded voice signal received from the voice CODEC to a selected output device under the control of the controller, so that different voice outputs are connected to different output devices.

10. The mobile terminal of claim 9, wherein the voice CODEC has a first output terminal assigned to one of two services being concurrently received, for outputting voice from the service, and a second output terminal assigned to the other service for outputting voice from the other service; and wherein the voice switch connects has first and second input terminals and first and second output terminals and the first and second input terminals to the first and second output terminals such that paths for outputting the voices from the services are established to different output devices.

11. The mobile terminal of claim 9, wherein the storage stores voice output information including voice output paths and voice output priority levels for the voice switch to establish the voice output paths, and the controller transmits the voice output information to the voice switch so that different voice outputs are connected to different output devices.

12. The mobile terminal of claim 10, wherein the storage stores voice output information including voice output paths and voice output priority levels for the voice switch to establish the voice output paths, and the controller transmits the voice output information to the voice switch so that the different voice outputs are connected to the different output devices.

13. The mobile terminal of claim 9, wherein the different output devices are a speaker and an earphone.

14. The mobile terminal of claim 10, wherein the different output devices are a speaker and an earphone.

15. The mobile terminal of claim 10, wherein the voice switch switches a voice signal received through the first input terminal to the first and second output terminals.

16. The mobile terminal of claim 10, wherein the voice switch switches a voice signal received through the second input terminal to the first and second output terminals.

17. The mobile terminal of claim 10, wherein the voice switch switches a voice signal received through the first input terminal to the first output terminal and a voice signal received through the second input terminal to the second output terminal.

18. The mobile terminal of claim 10, wherein the voice switch switches a voice signal received through the first input terminal to the second output terminal and a voice signal received through the second input terminal to the first output terminal.

19. A voice processing method which provides for a concurrent service that concurrently provides at least two services, each service requiring voice output, in a mobile terminal capable of switching different voice outputs to different output devices, comprising the steps of:
prioritizing services that can be provided as the concurrent service;
determining whether a first service and a second service are to be provided concurrently if the second service is received during the first service in progress, outputting voices from the first and second services via different output paths if the first and second services are provided concurrently;
determining whether the first and second services are provided as the concurrent service if the first and second services are not provided concurrently;
selecting one of the first and second services and outputting voice from the selected service if the first and second services are not provided as the concurrent service; and
selecting one of the first and second services that has a higher priority level and outputting voice from the higher-priority service if the first and second services are provided as the concurrent service.

20. The voice processing method of claim 19, further comprising the step of, upon input of a voice switching signal during the voice output from the high-priority service, switching to voice output from the other service.

21. The voice processing method of claim 19, wherein the services are prioritized by user selection.

22. The voice processing method of claim 20, wherein the services are prioritized by user selection.

23. The voice processing method of claim 19, wherein the services are prioritized by prioritizing programs for performing the services.

24. The voice processing method of claim 20, wherein the services are prioritized by prioritizing programs for performing the services.

25. The voice processing method of claim 20, wherein the voice switching signal is generated by selecting a predetermined unused ASCII code.

26. The voice processing method of claim 19, wherein if the first and second services are provided concurrently, the output paths of voices from the first and second services are predetermined.

27. The voice processing method of claim 19, wherein the step of determining if the first and second services are to be concurrently provided comprises the steps of:
activating a voice output selection window if the first and second services are provided concurrently;
setting an output path for each of the first and second services in the voice output selection window.

28. The voice processing method of claim 27, further comprising the step of, upon receipt of a path reset signal during the voice output from the first and second services, activating the voice output selection window.

29. The voice processing method of claim 28, wherein the path reset signal is generated by selecting a predetermined unused ASCII code.

30. A computer-readable recording medium in a mobile terminal having a processor and capable of switching different voice outputs to different output devices, comprising a program,
wherein the program performs a first function for prioritizing services that can be provided as a concurrent service, a second function for determining whether a first service and a second service are to be provided concurrently if the second service is received during the first service in progress, a third function for outputting voices from the first and second services via different output paths if the first and second services are provided concurrently, a fourth function for determining whether the first and second services are provided as the concurrent service if the first and second services are not provided concurrently, and selecting one of the first and second services and outputting voice from the selected service if the first and second services are not provided as the concurrent service, and a fifth function for selecting one of the first and second services that has a higher priority level and outputting voice from the higher-priority service if the first and second services are provided as the concurrent service.
